(19) United States
(12) Patent Application Publication
(10) Pub. No.: US 2004/0020772 A1
(43) Pub. Date: Feb. 5, 2004

(54) Method and system for measuring active animal glue concentration in industrial electrolytes

(76) Inventors: Wlodzimierz Bas, Glogow (PL); Boguslaw Fuglewicz, Wroclaw (PL); Jan Garbaczewski, Glogow (PL); Olympia Gladysz, Wroclaw (PL); Jan Jagiello, Glogow (PL); Przemyalaw Los, Wroclaw (PL); Grzegorz Malachowicz, Wroclaw (PL); Stanislaw Nosal, Glogow (PL); Stanislaw Orzecki, Glogow (PL); Gtanislawa Plinska, Oborniki Slaskie (PL); MIroslaw Przysiezny, Glogow (PL); Piotr Romanowicz, Glogow (PL); Grzegorz Szwancyber, Glogow (PL); Roman Urbanowicz, Glogow (PL); Marian Warmuz, Glogow (PL)

Correspondence Address: Horst M Kasper, 13 Forest Drive, Warren, NJ, 07059, US

(21) Appl. No.: 10/344,301

(22) PCT Filed: Apr. 2, 2001
(86) PCT No.: PCT/PL01/00027

(30) Foreign Application Priority Data
Aug. 7, 2000 (PL) P341922

(51) Int. Cl. G01N 27/26

(52) U.S. Cl. 204/434; 205/574; 205/789

(57) ABSTRACT

A method consists in measuring ac impedance spectrum using gold, platinum or carbon working ultramicroelectrodes (1). The direct current DC potential pulse which overlaps with alternating current AC signal of an amplitude in the range from 0.005 to 0.015 V and frequency in the range from 10⁻² to 10⁶, Hz is applied at the electrode. The value of said DC potential pulse for a process of copper electrorefining is in the range from −0.4 to −0.9 V in relation to a platinum reference electrode (2). Resistance values characteristic of a given electrolyte (E) are obtained from said AC impedance spectrum and compared with standard characteristic obtained by standard additions method. A measuring system consist of electrodes (1, 2, 3) placed inside a measuring cell (4) filled with flowing industrial electrolyte. The electrodes (1, 2, 3) are joined to a spectrum analyser (12) controlled by a programming apparatus (13)

### FIELD OF THE INVENTION

This invention relates to a method and system for measuring active animal glue concentration for use in particular in copper electrorefining processes.

### BACKGROUND OF THE INVENTION

Fire refined anode copper undergoes electrorefining in order to obtain the highest quality copper. This process is carried out in the following way: cast in the metallurgical process anodes are hung in electrolytic tanks filled with electrolyte composed of aqueous solution of copper sulphate and sulphuric acid.

Thin pure copper sheets acting as cathodes are placed between the anodes. During copper electrolysis, copper is passing from an anode into the solution while electrodeposition of copper from the solution is taking place on a cathode.

The process of copper electrorefining is carried out at the temperature of about 60° C. and a continuous flow of electrolyte through the electrolytic tanks is maintained. Copper is deposited on the cathode in the form of crystals which tend to assume irregular shapes, so called dendrites. The formation of dendrites is highly inadvisable because sedimentation anode slime tends to settle on them. Dendrites are also the main cause of short-circuit which occurs between a cathode and an anode. Addition of surface active substances such as thiourea and active animal glue to the electrolyte prevents dendrites formation. These additions are systematically used up during the process so their quantity is replenished continuously. Cathodes of required quality are obtained by using precisely defined quantities of additions. Too small or too big doses of thiourea and active animal glue always cause deterioration of cathode quality. Direct measurement of active animal glue concentration in the electrolyte is not possible since the mechanism of glue action to industrial electrolyte has not been known so far. It is known, however, that one of the significant elements of glue activity in the electrolyte is inhibition of electron/charge transfer reaction due to copper ion electrochemical reduction in the solution. The presence of glue decreases electron/charge transfer rate thus the whole process of cathodic reduction is controlled by rate of electron/charge transfer process as well as adsorption on the electrode.

The method of defining surface-active substances such as thiourea and animal glue content in copper electrorefining composition is known from patent description SU 1742706 A1. On the basis of copper electrode polarisation magnitude in copper electrorefining solution at the current density in the range from 250 to 350 A/m², the glue concentration is determined after having eliminated thiourea by hydrogen peroxide. The thiourea concentration is determined in accordance with earlier determined glue content. The glue activated earlier in sulphate electrolyte at the temperature of 60-65° C. for 3-4 hours is used for obtaining standard curves which enable to determine the components concentrations.

This method has limited reproducibility because the shape of polarisation curves depends on electrolyte composition in particular on Cu (I) and Cu (II) concentration. Changes of these ion concentrations may cause significant changes of potential registered at the well-fitted current density. As a result, accuracy of this method based on determining potential drop may differ in some cases considerably from declared value of ±0.1 mg/l. Two determinations are performed in this method, thiourea is removed in one sample so the determination time is long and the whole process is relatively laborious. As there is always certain concentration of animal glue and thiourea in industrial electrolytes, said method implies performing all standard curves for each sample, initial concentration value being virtually unknown.

Electrochemical impedance spectroscopy is known from the paper by Loś P. “AC Impedance Electrochemical Studies of Solid Rough and Porous Electrodes, and Ultramicroelectrodes (UME)”, School of Medicine, Wroclaw 1996 as well as from the textbook by Bogusz W., Krok F.: Solid Electrolytes —Electrical Properties and Methods for Measurement, WNT, Warsaw 1995. This method being an electrochemical in situ method which may be used for electrochemical reaction mechanism and kinetics studies at rough and porous electrodes. In the case of these electrodes it is not possible to understand the phenomena that occur at electrode/electrolyte interface without understanding the electrode structure. The basic experimental material of impedance spectroscopy is a set of sample impedance values for chosen discrete frequencies covering the widest possible range of about 10⁻³ Hz to radio frequency in the order of several hundreds of kHz. The following measuring methods are used in this range;

oscillographic methods for the highest frequencies,

bridges,

spectrum analysers FRA—Frequency Response Analysers,

time domain measurements combined with subsequent Fast Fourierr Transformation (FFT).

In order to measure high impedances the studied system should be placed inside a Faradaic cage.

The combination of impedance spectroscopy and ultramicroelectrodes is particularly useful for studying electrochemical cells, sensors and high impedance systems. Ultramicroelectrodes are electrodes which have at least one linear dimension in the order of several micrometers. They possess numerous properties particularly useful for electrochemical studies. As a result of their small dimensions both electrolyte resistance R_{S} (expressed in Ω cm²) and double layer charging current are reduced to minimum.

### OBJECTS OF INVENTION

I. The invention relates to a method of measuring active animal glue concentration in industrial electrolytes, especially in copper electrorefining, using electrochemical impedance spectroscopy (EIS) in the range of frequencies 10⁻²-10⁶ Hz at an ultramicroelectrode.

The object of the invention is to register impedance spectrum at a gold, platinum or carbon ultramicroelectrode under conditions of DC potentiostatic signal the value of which is comprised in the range of electroreduction metal ions potential in industrial electrolyte, the most favourable value is for copper ions from −0.4 to −0.9 V. Said registering occurs in relation to platinum reference electrode and the DC potentiostatic signal applied at the working ultramicroelectrode overlaps with AC signal of an amplitude in the range from 0.005 to 0.015 V. Impedance spectrum obtained in this way enables to determine the resistance value characteristic of a given industrial electrolyte. Said resistance value is compared to the standard resistance value determined experimentally for optimum animal glue content on the basis of standard characteristic made by standard additions method obtained from impedance spectrum measurements.

The resistance value characteristic of a given electrolyte is determined from the point of intersection of impedance spectrum on a complex plane with real axis at the side of low frequencies or by an approximation of a spectrum part using equivalent electric circuit composed of determined resistance and capacity connected in parallel which are in turn connected in series with the second resistance defining high-frequency electrolyte resistance or as a real part of impedance measurement at one chosen frequency in the range from 10 to 500 Hz.

II. The invention relates to a system for measuring active animal glue concentration in industrial electrolytes especially in copper electrorefining process. Said system comprises at least two electrodes: working and reference one. They are placed inside a Faradaic cage.

The object of the invention is to use platinum, gold or carbon ultramicroelectrode as a working electrode which has a diameter of 1 to 50 μm while a platinum or copper reference electrode has a surface of 0.1-0.6 cm². Both electrodes are placed inside a measuring cell surrounded by an aqueous coat The measuring cell is connected to an electrolyte tank by an inlet pipe. An outlet pipe is led out from the measuring cell to electrorefining system. The electrodes are connected to the impedance spectrum analyser whose controlling entry is joined to a programming apparatus exit while measuring exit is connected to a recording entry of the programming apparatus. It is advisable that dosage programming apparatus exit is joined to a controlling entry of a glue container.

The studies of electrochemical methods have shown that electrochemical impedance spectroscopy (EIS) being a method in situ is the most suitable of all to study effectively animal glue in an electrolyte. Combining electrochemical impedance spectroscopy (EIS) with an ultramicroelectrode (UME) enables to shorten the concentration measuring time to about two minutes (including analysis of the results and cleaning of the working electrode). The mass transport rate at an UME is significantly bigger than at a normal size electrode which results in immediate establishing of glue adsorption equilibrium (steady-state) at an UME. The registered impedance spectrum can be used for determining active animal glue concentration in a simple way because at low frequencies steady-state is established at UME. This method, called GlueDet, is in accordance with the invention. It is of about 3.5% accuracy and high sensitivity of about 0.06 mg/l of active glue. By sensitivity is meant the smallest value of entry signal change, i.e. active animal glue concentration change causing measurable exit signal change. In addition, the measurement of impedance spectrum in the range of frequencies from several thousand Hz to several Hz makes it possible to obtain such Faradaic parameters during one experiment as for example: diffusion coefficient and charge/electron transfer reaction rate constant. It is known that glue presence in industrial electrolyte decreases the rate of electron transfer process at electrode/electrolyte interface. It should be expected then that charge transfer resistance should increase when active animal glue concentration increases. The combination of EIS and UME enable to obtain a very effective measuring instrument of said kinetic effect.

The possibility of obtaining a steady-state at an UME at low frequencies values permits to acquire a standard curve for the dependence of the resistance measured in these conditions, i.e. in an intersection point of impedance diagram on a complex plane with real axis Z′ at the side of low frequencies, on the glue concentration. Said resistance is a sum of electrolyte and charge transfer resistance the latter being a characteristic of charge transfer kinetic process. Though the analysis of a whole spectrum may provide significant information about kinetics and mechanism of copper reduction process in industrial electrolytes, it can be said that for analytical purposes the resistance analysis according to glue concentration is sufficient. The method of glue determination in accordance with the invention may also be used in kinetic studies of glue hydrolysis in relation to time and temperature.

Standard curves measurements of resistance dependence upon active glue concentration is carried out by the standard additions method. This method is used because the matrix composition of analysed sample is not known. The method proposed in the invention is simple and does not require any additions or changes, e.g. de-oxidation of analysed solution It has been assumed that said method will be used for determining active glue concentration because only part of the glue hydrolysis components show activity in relation to copper electroprocessing. On the basis of the literature data analysis it can be stated that active glue or rather its hydrolysis products should possess adequately high molar mass; it does not show activity below molar mass activity. It is widely known that in order for the glue to show activity, its hydrolysis products have to contain components whose molar mass is higher than 10000. Higher glue components activity of greater molar mass is explained by the possession of greater number of functional groups which may adsorb strongly on the cathode surface.

Said measurement system and results analysis method are simple and may be totally automated. It means that continuous active glue concentration measurements may be carried out in several measurement cycles automatically. The result of the measurement is received on the monitor screen or printed directly in mg/l of active animal glue in industrial electrolyte. The number of studied cycle, a date and hour of carried determination may also be given. Said system is totally automated and enables to control active glue concentration in real time thus the active animal glue dosage to industrial electrolyte may also be automated. The operation time of one analysis is very short and does not exceed two minutes.

### BRIEF DESCRIPTION OF THE DRAWINGS

The object of the invention is shown by way of examples of embodiment with reference to the accompanying drawings, in which:

FIG. 1 is a diagram illustrating a system for measuring animal glue concentration in industrial copper electrorefining.

FIG. 2 is an impedance spectrum on a complex plane, on Y-axis imaginary part—Z″, on X-axis real part Z′.

FIG. 3 is an equivalent circuit used for approximation of the experimental results obtained at an UME.

FIG. 4 is a standard characteristic of resistance dependence in relation to animal glue concentration in electrolyte.

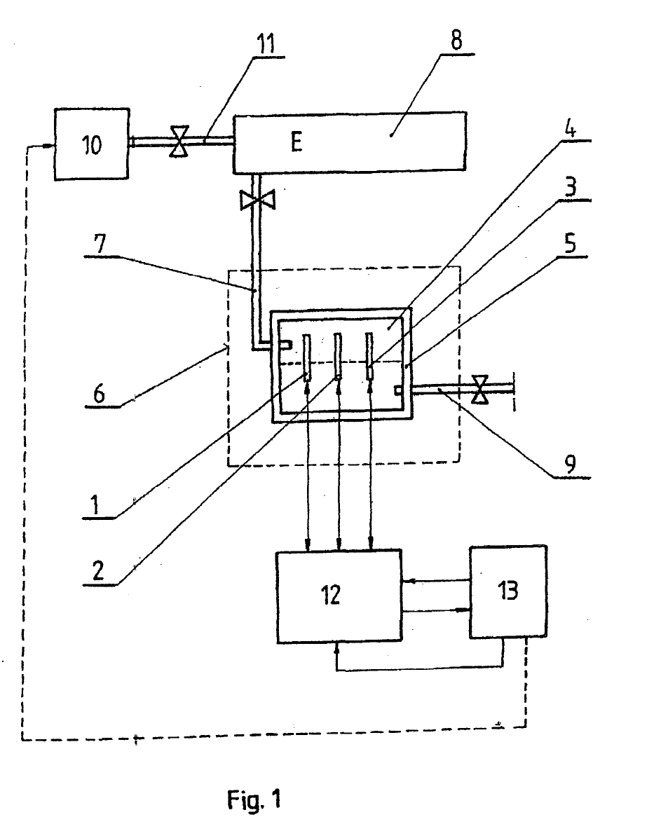

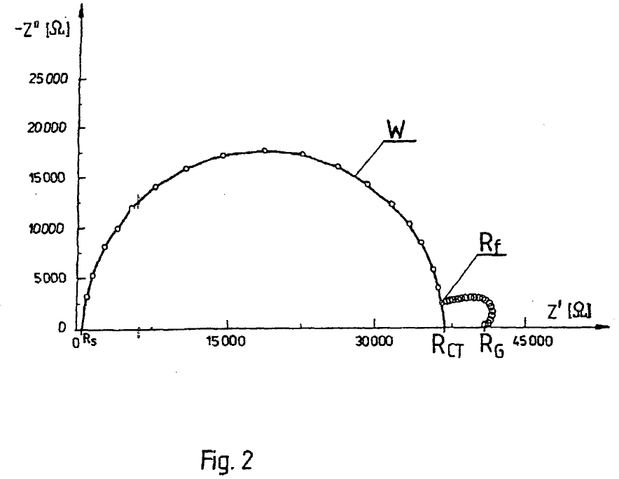

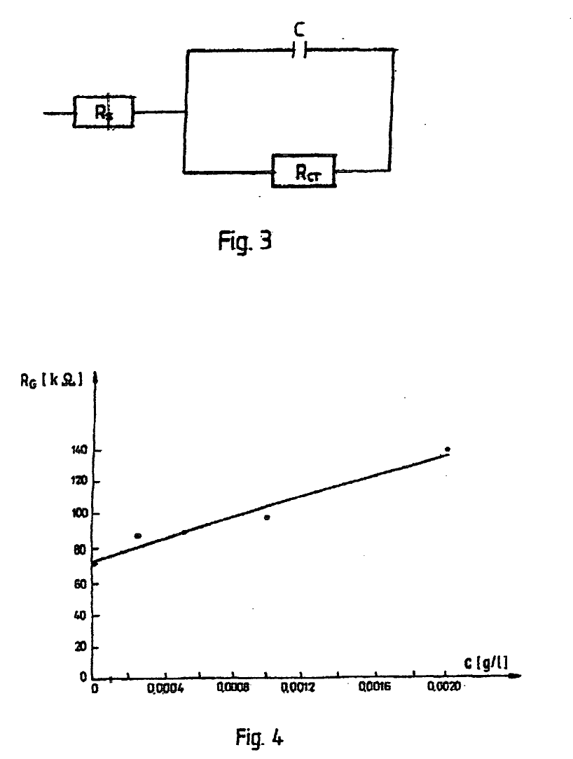

### EXAMPLES

### Example 1

The described system is used for measuring animal glue concentration in copper electrorefining system. Three electrodes, working ultramicroelectrode (1) is made of gold wire of a diameter 40 μm, auxiliary electrode (2) is a platinum plate 0.05 cm thick and surface of 0.5 cm², and calomel reference electrode (3) are immersed up to 1 cm in the electrolyte inside a glass measuring cell (4) surrounded by an aqueous coat (5). The system is placed in a Faradaic cage (6). A pipe (7) whose inlet is put in a tank (8) of a electrolyte (E) is inserted to the glass cell (4). The second pipe (9) fastened in the glass cell is led out to electrorefining system. An animal glue container (10) is connected by a pipe (11) to the tank (8). The electrodes (1, 2, 3) are connected to an electrochemical meter (12), i.e. spectrum analyser (FRA). The controlling entry of the meter (12) is connected to an exit of a programming apparatus (13) which comprises microcomputer Pentium and a measuring exit is joined to a recording entry of the programming apparatus (13). The dosage programming apparatus exit/outlet (13) is connected to a controlling entry/inlet of glue container (10).

### Example 2

The method of determining standard characteristic is described in the presented system. For given conditions of animal glue dosage in industrial electrolyte (E) during copper electrorefining process, standard resistance (R_{G}) characteristic is taken off in relation to active animal glue concentration in the electrolyte using impedance spectroscopy method for measuring several points which correspond to gradual addition of defined glue portions. The results are approximated by a linear relationship of said standard resistance vs. said active animal concentration.

### Example 3

The measurement of glue concentration in electrolyte (E) in industrial process is carried out when there is a continuous flow of electrolyte (E) through a measuring cell (4) at flow intensity chosen appropriately for existing conditions. DC potentiostatic signal of −0.5 V with superimposed AC signal of an amplitude of 0.010 V and frequency range from 200 kHz to 0.1 Hz is applied cyclically by a programming apparatus (13). On the basis of the registered spectrum, resistance value characteristic of the studied electrolyte is determined. The determined value is written in a standard characteristic from which can be read off animal glue concentration. There are three methods to determine the resistance characteristic of said electrolyte (E).

### Example 4

The value of resistance (R_{G}) characteristic of said electrolyte (E) is read off from impedance spectrum (W) at the point of its intersection with a real axis Z′ at the side of low frequencies.

### Example 5

The value of resistance (R_{CT}) is read from said impedance spectrum W using approximation to said real axis Z′.

### Example 6

The value of resistance (R_{F}) is read off for a frequency of 50 Hz using one point impedance measurement in said electrolyte (E).

### LIST OF SYMBOLS

1—UME—working ultramicroelectrode

2—platinum auxiliary electrode

3—calomel reference electrode

4—measuring cell

5—aqueous coat

6—Faradaic cage

7—electrolyte delivering pipe

8—electrolyte tank

9—draining pipe

10—glue container

11—pipe

12—FRA—Frequency Response Analysers

13—programming apparatus with microcomputer Pentium

E—electrolyte

EIS—Electrochemical impedance spectroscopy

FFT—Fast Fourierr Transformation

AC—alternating current

DC—direct current

C—capacitance

R_{F}, R_{G} —characteristic resistance

R_{S}—electrolyte resistance

R_{CT}—charge resistance

W—impedance spectrum

1. A method of measuring active animal glue concentration in industrial electrolytes, especially in copper electrorefining process, using electrochemical impedance spectroscopy (EIS) in the range of frequencies from 10⁻² to 10⁶ Hz, characterized by registering said AC impedance spectrum at an ultramicroelectrode (gold, platinum or carbon) under said DC potentiostatic component whose value is comprised in the range of electroreduction of metal ions potential in industrial electrolyte, the most favourable value for copper ions in the range from −0.4 to −0.9 V, in relation to a platinum or copper reference electrode, and said potentiostatic signal applied at the working electrode overlaps with said AC signal of an amplitude in the range from 0.005 to 0.015 V, while from the impedance spectrum obtained in this way the resistance value characteristic of a given industrial electrolyte is determined and said resistance value is compared with standard resistance value determined experimentally for optimum animal glue concentration on the basis of standard characteristic made by standard additions method realised by impedance spectrum registering.

2. The method defined in claim 1, wherein the resistance value (R_{G}) characteristic of a given electrolyte is obtained from the point of intersection of impedance spectrum (W) on a complex plane Z″, Z′ with real axis Z′ at the side of low frequencies.

3. The method defined in claim 1, wherein the resistance value characteristic of a given electrolyte (E) is obtained by an approximation of a spectrum part using equivalent electric circuit consisting of determined resistance (R_{CT}) and capacitance (C) connected in parallel which are in turn connected in series with the second resistance (R_{S}) defining high-frequency resistance of an electrolyte (E).

4. The method defined in claim 1, wherein the resistance value (R_{F}) characteristic of a given electrolyte (E) is determined as a real part of impedance measurement at one chosen frequency in the range from 10 to 500 Hz.

5. A system for measuring active animal glue concentration in industrial electrolytes, especially in copper electrorefining process and said system comprises at least two measuring electrodes placed inside a Faradaic cage characterized in that, that said platinum, gold or carbon ultramicroelectrode (1) acting as said working electrode has a diameter of 1-50 μm, while said reference electrode (2) has a surface of 0.1-0.6 cm² and said electrodes (1, 2, 3) are placed inside a measuring cell (4) which is surrounded by an aqueous coat (5) and said measuring cell (4) is connected to an electrolyte (E) tank (8) by an inlet pipe (7) and an outlet pipe (9) is led out to an electrorefining system from said measuring cell (4) said electrodes (1, 2, 3) are joined to impedance spectrum analyser (12) whose controlling entry is joined to said programming apparatus (13) exit while measuring exit is joined to a registering entry of said programming apparatus (13).

6. The system defined in claim 5, wherein said dosage programming apparatus (13) exit is joined to a controlling entry of a glue container (10).
